(19) United States
(12) Patent Application Publication
(10) Pub. No.: US 2009/0327269 A1
(43) Pub. Date: Dec. 31, 2009

(54) PATTERN GENERATION

(75) Inventors: STELIOS PAPARIZOS, SAN JOSE, CA (US); CHRISTOPHER WALTER ANDERSON, REDMOND, WA (US); WEI LIU, BELLEVUE, WA (US); AJAY NAIR, REDMOND, WA (US); NAGA SRINIVAS VEMURI, REDMOND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/163,475

(22) Filed: Jun. 27, 2008

(51) Int. Cl. G06F 17/30

(52) U.S. Cl. 707/5; 707/E17.017

(57) ABSTRACT

Generation of patterns used to facilitate search queries is provided herein. A pattern includes a sequence of token classes and new token classes. A sample query is parsed to identify tokens within the sample query that match a token associated with a referenced set of token classes. New token classes are generated for unidentified tokens within the sample query. A pattern is generated by substituting the identified tokens of the sample query with corresponding token classes and substituting the unidentified tokens of the sample query with corresponding new token classes.

### BACKGROUND

Some search engines employ rule-based grammars to route queries to corresponding domains of information to provide, for instance, instant answers for query searches. The rule-based grammars may be used to classify search queries received at a search engine, annotate the queries, and route the queries to appropriate data sources to find and return results for the queries. For instance, suppose a user enters the search query: “weather in Seattle.” A grammar may be used to identify that Seattle is a city and weather is a keyword. The grammar may also be used to identify an appropriate data source to provide an answer (e.g., a data source containing weather information) and assists in evaluating the query to provide an appropriate response. Accordingly, by employing a grammar, weather information for Seattle could be provided as an instant answer to the search query in addition to traditional web page search results.

Most grammars used are relatively large with multiple patterns and combinations of items. The patterns are utilized to extract meaning from queries. Accordingly, patterns enable an appropriate instant answer to be provided in response to a user query. Manually generating such patterns to provide, for instance, instant answers to search queries has been a very difficult and time-consuming task.

### SUMMARY

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

Embodiments of the present invention generally relate to automatically generating patterns to be used within rule-based grammars for query searches. A pattern includes a sequence of token classes, which are each a logical grouping of tokens, which, in turn, are each a sequence of characters. A sample query is parsed to identify tokens within the sample query that match a token associated with a referenced set of token classes. New token classes are generated for unidentified tokens within the sample query. In embodiments, an unidentified token can include a word, a phrase, or other sequence of characters. A pattern is generated by substituting the identified tokens of the sample query with corresponding token classes and substituting the unidentified tokens of the sample query with corresponding new token classes.

### BRIEF DESCRIPTION OF THE DRAWINGS

The present invention is described in detail below with reference to the attached drawing figures, wherein:

FIG. 1 is a block diagram of an operating environment suitable for use in implementing an embodiment of the present invention;

FIG. 2 is a block diagram of an exemplary computing system architecture for use in implementing an embodiment of the present invention;

FIG. 3 is an exemplary computer system for generating patterns, in accordance with an embodiment of the present invention;

FIG. 4 is a flowchart illustrating a general, overview method in which a pattern is generated in accordance with an embodiment of the present invention; and

FIG. 5 is a flowchart illustrating a more specified method for generating a pattern in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to generating patterns used in rule-based grammars that are used for query search. Accordingly, in one aspect, an embodiment of the present invention is directed to a method for generating patterns. The method includes referencing a sample query, the sample query comprising a string of characters. The method also includes referencing a plurality of token classes, wherein each of the token classes within the plurality of token classes is associated with a token class identifier and comprises a logical grouping of tokens. The method next includes parsing the sample query to identify one or more predetermined tokens within the sample query that match at least one of the tokens corresponding with the plurality of referenced token classes. The method also includes replacing each of the one or more predetermined tokens with the corresponding token class identifier to generate a pattern representing the sample query.

In another embodiment, an aspect is directed to one or more computer-storage media embodying computer-useable instructions that, when employed by a computing device, cause the computing device to perform a method. The method includes referencing a sample query. The method also includes referencing token classes, each of the token classes including a set of related tokens. The method further includes identifying known tokens within the sample query and unknown tokens within the sample query, wherein the known tokens correspond with the referenced token classes having the set of related tokens. The method next includes generating a new token class for each of the unknown tokens. The method further includes associating a token class identifier with each of the known tokens and a new token class identifier with each of the unknown tokens. The method also includes substituting each of the known tokens with the associated token class identifier and each of the unknown tokens with the associated new token class identifier to generate a pattern.

A further embodiment of the present invention is directed to one or more computer-storage media embodying computer-useable instructions that, when employed by a computing device, cause the computing device to perform a method. The method includes receiving a set of sample queries, the set of sample queries input by pattern generation users, wherein each of the sample queries comprise tokens. The method also includes referencing a set of token classes, each of the token classes represented by a token class identifier and comprising a group of related tokens. The method further comprises utilizing the set of token classes to identify predetermined tokens within the set of sample queries, wherein a predetermined token is identified as such if it matches a token within the referenced set of token classes. The method also includes associating any predetermined tokens with the corresponding token class identifier. The method includes recognizing unidentified tokens within the sample queries and generating a new token class having a new token class identifier for each of the unidentified tokens. The method next includes generating a pattern for each of the sample queries, wherein patterns are generated by replacing any predetermined tokens within the sample queries with the corresponding token class identifier and replacing any unidentified tokens within the sample queries with the corresponding new token class identifier. The method also includes eliminating any duplicate patterns and generating a grammar usable by a search engine to route search queries to corresponding domains of information to find and return information for the search queries, the grammar comprising a version of each generated pattern, each pattern comprising a sequence of token class identifiers and new token class identifiers.

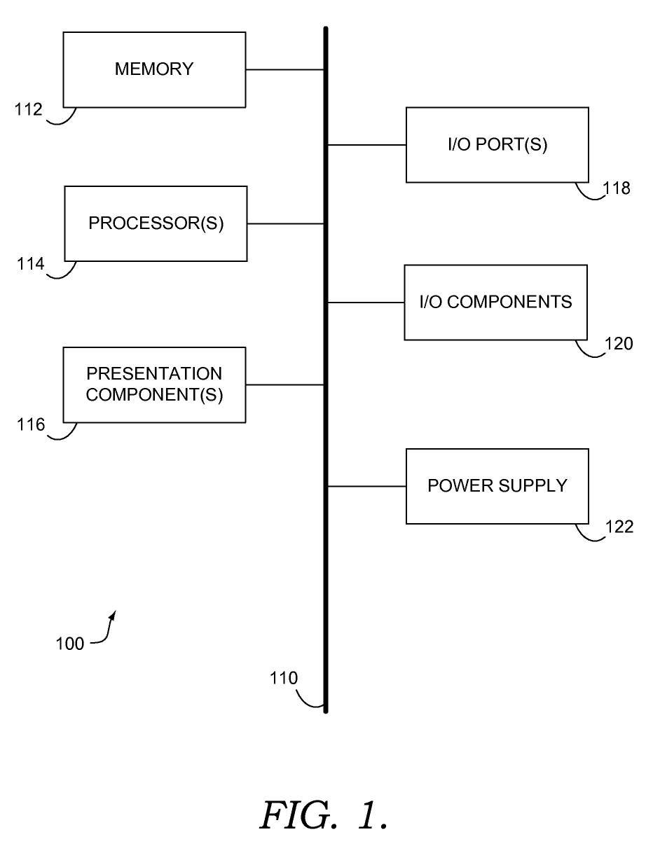

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing module, vibrating module, etc. I/O ports 118 allow computing device 100 to be logically coupled to other devices including I/O components 120, some of which may be built in. Illustrative modules include a microphone, joystick, game pad, satellite dish, scanner, printer, wireless device, etc.

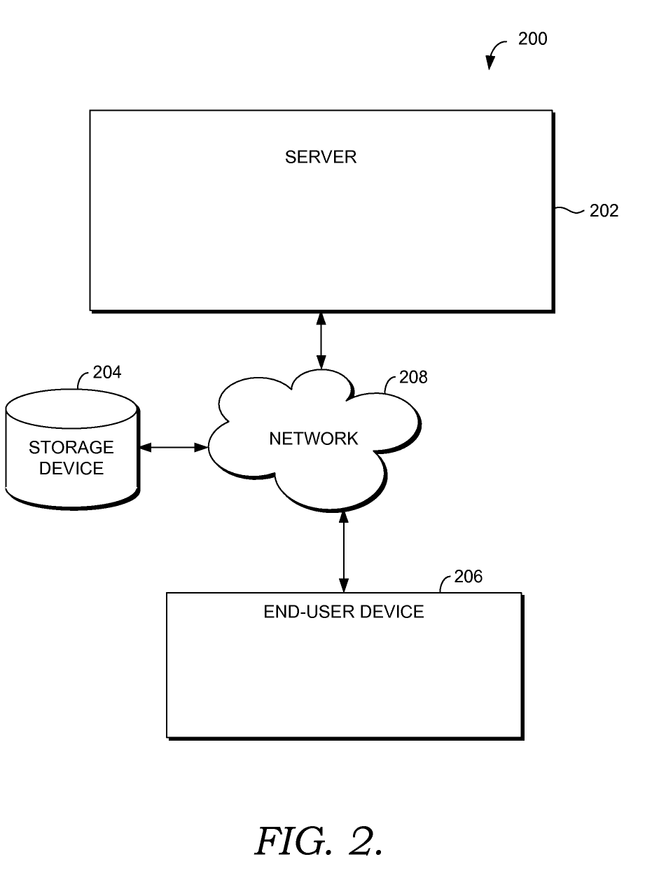

With reference to FIG. 2, a block diagram is illustrated that shows an exemplary computing system architecture 200 configured for use in implementing an embodiment of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single component or combination of components illustrated therein.

Computing system architecture 200 includes a server 202, a storage device 204, an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with grammars, patterns, token classes, tokens, domain data, sample queries, and the like. In embodiments, the storage device 204 is configured to be searchable for one or more of the items stored in association therewith. It will be understood and appreciated by those of ordinary skill in the art that the information stored in the storage device 204 may be configurable and may include any information relevant to grammars, patterns, token classes, tokens, domain data, sample queries, and the like. The content and volume of such information are not intended to limit the scope of embodiments of the present invention in any way. Further, though illustrated as a single, independent component, the storage device 204 may, in fact, be a plurality of storage devices, for instance a database cluster, portions of which may reside on the server 202, the end-user device 206, another external computing device (not shown), and/or any combination thereof.

Each of the server 202 and the end-user device 206 shown in FIG. 2 may be any type of computing device, such as, for example, computing device 100 described above with reference to FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 202 may include any type of application server, database server, or file server configurable to perform the methods described herein. In addition, the server 202 may be a dedicated or shared server. One example, without limitation, of a server that is configurable to operate as the server 202 is a structured query language (“SQL”) server executing server software such as SQL Server 2005, which was developed by the Microsoft® Corporation headquartered in Redmond, Wash.

Components of server 202 (not shown for clarity) may include, without limitation, a processing unit, internal system memory, and a suitable system bus for coupling various system components, including one or more databases for storing information (e.g., grammars, patterns, token classes, tokens, domain data, sample queries, and the like). Each server typically includes, or has access to, a variety of computer-readable media. By way of example, and not limitation, computer-readable media may include computer-storage media and communication media. In general, communication media enables each server to exchange data via network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 202 is illustrated as a single box, one skilled in the art will appreciate that the server 202 is scalable. For example, the server 202 may in actuality include 500 servers in communication. Moreover, the storage device 204 may be included within the server 202 or end-user device 206 as a computer-storage medium. The single unit depictions are meant for clarity, not to limit the scope of embodiments in any form.

Embodiments of the present invention are generally directed to generating patterns used for query search via rule-based grammars. In accordance with embodiments, known and unknown tokens within a sample query are identified. The known and unknown tokens are replaced with token class identifiers that are associated with the known and unknown tokens. In embodiments, token class identifiers for the unknown tokens are dynamically generated during the generation of the pattern. By replacing the tokens of the query with corresponding token class identifiers, a pattern is generated.

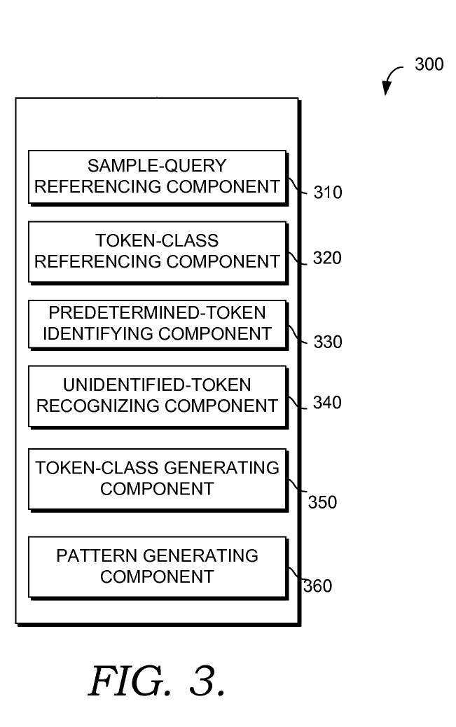

FIG. 3 illustrates an exemplary computer system 300 for generating one or more patterns. As used herein, a pattern refers to a sequence of token classes and/or new token classes, or identifiers thereof, in a particular order that is used to describe or capture queries. A token class is a logical grouping of tokens, and each token is a string of one or more characters. A token can include, but is not limited to, a phrase, a word, a number, a symbol, a letter, an operator, or a sequence thereof. By way of example, a token could be a particular basketball player, such as “Michael Jordan.” The token could then be included in a corresponding token class, for instance, identified as “basketball players,” which would include a list of tokens representing basketball players (e.g., Michael Jordan, Larry Bird, Julius Erving, etc.). The token class “basketball players” could then be included in a pattern (e.g., <points scored by><basketball player>).

Patterns can be utilized to generate rule-based grammars that are used to provide results in response to a query. As used herein, a grammar is a set or list of one or more patterns or rules. Rules or patterns will be used interchangeably herein. Grammars are often used by search engines to route queries to corresponding domains of information (i.e., data source) to provide, for instance, instant answers for query searches. The grammars may be used to classify search queries received at a search engine, segment and annotate the queries, and route the queries to appropriate data sources to find and return results for the queries.

As shown in FIG. 3, an exemplary computer system 300 includes a sample-query referencing component 310, a token-class referencing component 320, a predetermined-token identifying component 330, an unidentified-token recognizing component 340, a token-class generating component 350, and a pattern generating component 360. In some embodiments, one or more of the illustrated components may be implemented as stand-alone applications. In other embodiments, one or more of the illustrated components may be integrated directly into the operating system of the server 202, a cluster of servers (not shown), and/or the end-user device 206. It will be understood by those of ordinary skill in the art that the components illustrated in FIG. 3 are exemplary in nature and in number and should not be construed as limiting. Any number of components may be employed to achieve the desired functionality within the scope of embodiments hereof. Further, components may be located on any number of servers or computers.

The sample-query referencing component 310 is configured to reference one or more sample queries. In embodiments, sample-query referencing component 310 references sample queries automatically, that is, without user intervention. A sample query, as used herein, is a query, or a representation thereof, utilized to generate a pattern. A query refers to a string of characters, such as a question, comment, phrase, word, or the like, for which a corresponding response is desired. Such a response might include, for example, search results, an instant answer, or any other response that corresponds to a query. An instant answer, as used herein, refers to an immediate or direct answer to a question or comment rather than a link to a website that might contain your answer. For example, assume a user inputs a query of “weather in Seattle.” In such a case, an instant answer might be displayed to a user that includes the current weather and/or weather forecast for Seattle. One skilled in the art will appreciate that an instant answer to a query can be displayed in addition to traditional web page search results. A query representation refers to an example query or an artificial query that is generated, at least in part, for use in pattern generation. Query representations might be generated by a user. For example, a pattern generation user might input one or more queries via end-user device 206. Alternatively or additionally, query representations can be automatically generated by a computer program.

In one embodiment, sample-query referencing component 310 references sample queries (e.g., queries or query representations) input by a user via a computing device, such as end-use device 206. Such sample queries might be received or retrieved upon a user inputting a sample query, or a submission thereof. Alternatively or additionally, sample-query referencing component 310 can receive or retrieve sample queries from one or more query logs, such as a user query log, a search engine query log, or the like. A user query log captures sample queries (e.g., queries or query representations) input by a user. A search engine query log captures sample queries input to and/or received by a search engine.

In embodiments, sample queries referenced by sample-query referencing component 310 can be positive sample queries, negative sample queries, or a combination thereof. Both positive and negative sample queries might be referenced by sample-query referencing component 310 such that more accurate grammars can be generated. A positive sample query refers to a sample query that would correspond with an appropriate or desired data source. As such, if a positive sample query is submitted as a query, desired results, such as an instant answer, would be provided to a user. A negative sample query refers to a sample query that would correspond with inappropriate or undesired data source. That is, a negative sample query can result in an undesired response (e.g., search result or instant answer). For example, assume a user would like to obtain search results for stock quotes of automobile manufactures. Further assume that the user inputs a query of “stock cars.” In such a case, “stock cars” is a negative sample query as the result of the query is likely an undesirable response, such as information related to stock cars used in automobile racing.

Sample queries may be identified as positive or negative in a variety of different manners within the scope of embodiments of the present invention. For instance, in some embodiments, a sample query may be manually identified as positive or negative based on user input. In other embodiments, sample queries may be algorithmically determined to be positive or negative using, for example, but not limited to, well known query classification techniques applicable in an offline process on sets of queries or query logs. Those skilled in the art will appreciate that a number of approaches may be used to identify sample queries that should likely result in a desired response and sample queries that should likely result in an undesired response.

The token-class referencing component 320 is configured to reference one or more token classes. In embodiments, token-class referencing component 320 references token classes automatically and without user intervention. As discussed above, a token class is a logical grouping of tokens. That is, a token class refers to a set of one or more related tokens. Tokens can be related or logically grouped based on, for example, categories, subject matter, meaning (e.g., synonyms, definitions, etc.), or the like. By way of example only, tokens related based on a “movie actor” category might include the following tokens: Brad Pitt, Tom Cruise, Denzel Washington, and the like. Tokens related based on the meaning of a “movie” might include the following tokens: movies, videos, films, pictures, features, and the like. In embodiments, a token class identifier is utilized to represent and/or describe a token class. Such a token class identifier might comprise, for instance, a word, a phrase, a deterministic function, a regular expression, or any other string of character that identifies the token class. For example, a token class including a list of tokens representing basketball players (e.g., Michael Jordan, Kobe Bryant, and Michael Beasley) might have a token class identifier of “basketball players.”

One skilled in the art will appreciate that any number of token classes can be referenced. In one embodiment, token-class referencing component 320 references a set or list of related token classes. Token classes might be related, for example, based on a category, subject matter, a data source, or any other attribute that indicates association. In embodiments, referenced token classes correspond with one or more data sources. A data source, as used herein, refers to related domain data or information that is used to provide, for examples, instant answers. Such data or information can be stored in one or more databases. A data source may include data or information associated with, for example, sports, movies, music, encyclopedia, dictionary, finances, weather, or the like. For example, assume a database of domain data exists that is related to movies (i.e., a data source containing movie information). In such a case, the “movie” data source may include token classes representing various facets of movies, such as, for example, actors, directors, movie titles, and the like. The domain data might be structured, for example, so that an “actor” token class includes one column listing actors, a “director” token class includes one column listing directors, a “movie title” token class includes one column listing movie titles, and the like. In such a case, token-class referencing component 320 might reference each of the token classes that correspond with the data source related to movies. In another embodiment, token-class referencing component 320 might reference all token classes notwithstanding the data source to which the token class corresponds.

Token classes can be generated or developed in a variety of different manners within the scope of embodiments of the present invention. For instance, in some embodiments, a token class may be manually generated based on input from a user, programmer, administrator, or the like. For example, a user might input or select related tokens to create a token class. In other embodiments, token classes may be automatically generated. Such an automatic generation may include the use of a website, an electronic dictionary, an electronic encyclopedia, an electronic thesaurus, or any other electronic document that can be accessed to generate token classes.

One skilled in the art will appreciate that a token class can include an infinite set or large set of tokens. For example, a price of a product or service can by any amount, such as $100.00, $101.00, $101.10, etc. Such token classes can be described using, for instance, a regular expression or a deterministic function that deterministically produces or recognizes tokens (e.g., a function that describes date and/or time). By way of example only, a “price” token class can be described as a regular expression, such as, for instance, ‘$’\d+(‘.’\d+)?. In such a case, \d represents a digit, + represents one or more, ? represents zero or one, and ‘$’ and ‘.’ correspond to the actual characters. Accordingly, the regular expression includes $100, $101, $101.1, and the like.

The predetermined-token identifying component 330 is configured to identify predetermined tokens within each sample query. If multiple sample queries are referenced, predetermined tokens are identified within each sample query. In embodiments, predetermined-token identifying component 330 identifies predetermined tokens automatically, that is, without user intervention. As previously discussed, a token is a string of one or more characters, such as a phrase, a number, a symbol, a letter, an operator, or a sequence thereof. A predetermined token or token, as used herein, refers to a token within a query that corresponds to or matches at least one token included within a token class. Predetermined token and known token will be used interchangeably herein. That is, a predetermined token, such as a word or phrase, is a token assigned to, included within, or associated with a particular token class (e.g., associated with a data source). For example, assume a token class is identified as “basketball players.” In such a case, predetermined tokens are tokens included in the token class such as, for example, Michael Jordan, Michael Beasley, Kobe Bryant, and the like.

Predetermined tokens may be identified in a variety of different manners within the scope of embodiments of the present invention. For example, parsing and/or tokenizing can be used to identify predetermined tokens within sample queries. In embodiments, predetermined-token identifying component 330 utilizes tokens included within the token classes referenced by token-class referencing component 320 to identify predetermined tokens. In such a case, an algorithm or a lookup approach can be used to identify such predetermined tokens. Accordingly, a portion of a sample query is identified as a predetermined token if it matches a token associated with a referenced token class. One skilled in the art will appreciate that in instances where a token class comprises a deterministic function or a regular expressions, the token class that describes infinite tokens can be used by predetermined-token identifying component 330 to identify predetermined tokens.

By way of example only, assume a sample query is “movies with Harrison Ford” and that token-class referencing component 320 references each token class associated with a “movie” data source including an “actor/actress” token class. Further assume that the “actor/actress” token class within the “movie” data source includes a list of tokens representing actors and actresses (e.g., Julia Roberts, Harrison Ford, Chevy Chase, etc.). Accordingly, the predetermined-token identifying component 330 parses the sample query “movies with Harrison Ford” and identifies “Harrison Ford” as a predetermined token within the sample query. Those skilled in the art will appreciate that a number of approaches may be used to identify predetermined tokens within one or more sample queries.

In embodiments, predetermined-token identifying component 330 identifies as many predetermined tokens as possible for a sample query. In instances where multiple predetermined tokens can be identified from at least a portion of a sample query (e.g., a word), in some embodiments, a token preference is utilized to identify a preferred predetermined token. A token preference refers to a manner of identifying a token that is preferred from among a set of possible tokens. A token preference might be, for instance, a preference for the longest token (e.g., greatest character length, word length, or the like), the shortest token (e.g., least character length, word length, or the like), the most frequently used token, or any other algorithm or method that can be utilized to select a preferred token from among a group of tokens. For example, assume a user inputs “cost of digital cameras” as a sample query. Further assume that the referenced token classes are utilized to identify that “camera,” “digital,” and “digital camera” are predetermined tokens. In a case where a token preference is for a longest token, the token “digital camera” having the greatest number of words would be identified as a preferred predetermined token.

The unidentified-token recognizing component 340 is configured to recognize unidentified or unknown tokens within sample queries. In embodiments, unidentified-token recognizing component 340 recognizes unidentified or unknown tokens automatically and without user intervention. Unidentified tokens and unknown tokens will be used interchangeably herein. In embodiments, unidentified tokens are dynamically recognized. As previously discussed, a token refers to a string of one or more characters and can include a word, a number, a symbol, a letter, a phrase, or a sequence thereof. An unidentified token, as used herein, refers to a token, such as a word or phrase, that is not identified as a predetermined token, for example, by predetermined-token identifying component 330.

Unidentified tokens can be recognized in a variety of different manners within the scope of embodiments of the present invention. For instance, in one embodiment, each word or character that is not associated with a predetermined token can be aggregated to form a single unidentified token. For example, assume a referenced sample query is “points scored by Kobe Bryant,” and a referenced token class includes a list of basketball players (e.g., Michael Jordan, Kobe Bryant, LeBron James). As “Kobe Bryant” of the sample query matches the “Kobe Bryant” token within a referenced token class, predetermined-token identifying component 330 identifies “Kobe Bryant” as a predetermined token. In such a case, unidentified-token recognizing component 340 could recognize that “points,” “scored,” and “by” are not included as predetermined tokens. Accordingly, unidentified-token recognizing component 340 might recognize “points scored by” as an unidentified token.

In an alternative embodiment, each word or string of characters (e.g., subgroup of characters) within a query that is not identified as a predetermined token might be recognized as an individual unidentified token. For example, again assume a referenced sample query is “points scored by Kobe Bryant,” and a referenced token class is a list of basketball players (e.g., Michael Jordan, Kobe Bryant, LeBron James). As such, predetermined-token identifying component 330 identifies “Kobe Bryant” as a predetermined token. In such a case, unidentified-token recognizing component 340 might recognize that “points,” “scored,” and “by” are each unidentified words and, thereby, unidentified tokens. Accordingly, unidentified-token recognizing component 340 might recognize each of “points,” “scored,” and “by” as unidentified tokens.

In other cases, an unidentified token might comprise a phrase, or combination of words, phrases, or series of characters, within a sample query. In such a case, unidentified-token recognizing component 340 might be configured to recognize such token phrases based on, for example, frequency, position, or the like. To recognize token phrases utilizing frequency, sample queries might be processed or preprocessed by unidentified-token recognizing component 340, or another component, to identify words that frequently appear adjacent relative to one another. In instances where words frequently appear next to each other, the phrase can be considered an unidentified token for which a token class should be generated.

By way of example only, assume that a referenced sample query is “points scored by Kobe Bryant,” and “Kobe Bryant” is recognized as a predetermined token. To determine whether any combination of the words “points,” “scored,” and “by” should be considered an unidentified token, the frequency of words appearing together should be determined. Assume 10,000 sample queries are analyzed, and it is determined that the words “points” and “scored” appear adjacent relative to one another in 5,000 of the sample queries. Based on the frequency of the words positioned next to each other, “points scored” is considered an unidentified token phrase. Accordingly, unidentified-token recognizing component 340 might recognize each of “points scored” and “by” as unidentified tokens.

To recognize unidentified token phrases utilizing position, sample queries might be analyzed to determine word or phrase position. For example, upon identifying predetermined tokens, each group of words appearing before, after, or between predetermined tokens might be considered a token. By way of example only, assume that a referenced sample query is “points scored by Kobe Bryant in 2008,” and “Kobe Bryant” is recognized as a predetermined token. In such a case, “points scored by” might be considered a first unidentified token and “in 2008” might be considered a second unidentified token.

The token-class generating component 350 generates one or more new token classes. In embodiments, token-class generating component 350 generates new token classes automatically, that is, without user intervention. In embodiments, such new token classes are dynamically generated. A new token class, as used herein, refers to a representation of an unidentified token (e.g., words or phrases) within a query. In embodiments, a new token class identifier is utilized to represent and/or describe a new token class. A new token class identifier might comprise, for instance, a word, a phrase, a deterministic function, a regular expression, or any other string of characters that identifies a new token class. New token classes can be generated or developed in a variety of different manners within the scope of embodiments of the present invention. In embodiments, token-class generating component 350 generates a new token class for each of the unidentified tokens within a sample query. Token-class generating component 350 might also provide annotations associated with any new token class.

Upon generation of one or more new token classes, such new token classes might be stored, such as, for example, in a table (e.g., hash table). New token classes that are stored can be accessible such that the new token classes can be utilized in other sample queries. As such, in a case where a new token class was previously generated, the new token class can be used in a subsequent sample query, for example, having the same word or combination of words. In such a case, in one embodiment, token-class generating component 350 generates a new token class in instances where a same or substantially similar new token class is not accessible to utilize. That is, if a new token class already created can be reused, such a new token class might be reused rather than generating another token class that is the same. Accordingly, token-class generating component 350 might be configured to recognize the same or similar new token classes already generated. One skilled in the art will appreciate that such new token classes can, in some embodiments, be included within an appropriate data source upon generation thereof.

The pattern generating component 360 is configured to generate one or more patterns. In embodiments, pattern generating component 360 generates patterns automatically and without user intervention. In one embodiment, pattern generating component 360 replaces or substitutes tokens within sample queries to obtain a sequence of token classes and/or new token classes, or identifiers associated therewith. By replacing tokens with token classes and/or new token classes, or identifiers associated therewith, a pattern is generated. In one embodiment, a predetermined token is replaced with the corresponding token class identifier and an unidentified token is replaced with the corresponding new token class identifier. In some cases, a token class or new token class, and identifiers associated therewith, can be determined via an algorithm or lookup table. That is, a token class that replaces a known token can be identified utilizing, for example, a storage device storing token classes and/or tokens, or the referenced token class including tokens associated therewith. In other cases, a token class or a new token class can be identified from, for example, predetermined-token identifying component 330 or token-class generating component 350, respectively. Pattern generating component 360 might also be configured to provide annotations associated with a generated pattern.

By way of example only, assume a query is “points scored by Kobe Bryant,” and a “basketball player” token class includes a list of basketball players (e.g., Michael Jordan, Kobe Bryant, LeBron James, Michael Beasley, etc.). As such, “Kobe Bryant” is identified as a predetermined token via predetermined-token identifying component 330. As the token “Kobe Bryant” corresponds with the token class identified as “basketball player,” “Kobe Bryant” in the query can be replaced with “basketball player.” Further assume that “points scored by” is recognized as an unidentified token and, as such, a new token class, “New Token Class 1” is generated to correspond with “points scored by.” Accordingly, “points scored by” in the sample query can be replaced by “New Token Class 1.” As such, the resulting pattern might be <New Token Class 1><Basketball Player>.

Because a few patterns can describe or match a multitude of queries, pattern generating component 360 can, in some embodiments, be configured to remove duplicate patterns. For instance, assume a first sample query is “points scored by Kobe Bryant” and a second sample query is “points scored by LeBron James.” In such a case, pattern generating component 360 might provide a first pattern “<New Token Class 1><Basketball Player>” for the first sample query and a second pattern “<New Token Class 1><Basketball Player>” for the second sample query. Accordingly, pattern generating component 360, or another component, can eliminate either the first pattern or the second pattern to reduce the number of patterns.

The generated patterns can be incorporated into one or more grammars. A grammar(s) may be provided in a variety of different manners within the scope of embodiments of the present invention. By way of example, and not limitation, a grammar may be provided using an XML format, a binary format, or the like, to represent the grammar. In embodiments, a grammar includes, for example, a set of patterns, a set of token classes associated with the patterns, and a set of new token classes associated with the patterns. A grammar may include, for example, a set of related patterns (e.g., patterns related based on data source, token classes, tokens, categories, subject matter, etc.). For example, a grammar may include patterns corresponding with a particular domain or data source. Alternatively, a grammar may include all generated patterns or a group of patterns generated at or during a particular time or time period.

Grammars can be formatted such that they can be utilized by a grammar engine. Accordingly, grammars can be used by search engines to route queries to corresponding domains of information to provide, for example, instant answers for query searches. The grammars might be used to classify search queries received at a search engine, segment and annotate the queries, and route the queries to appropriate data sources to find and return results for the queries. Such results can be presented to a user via a display screen.

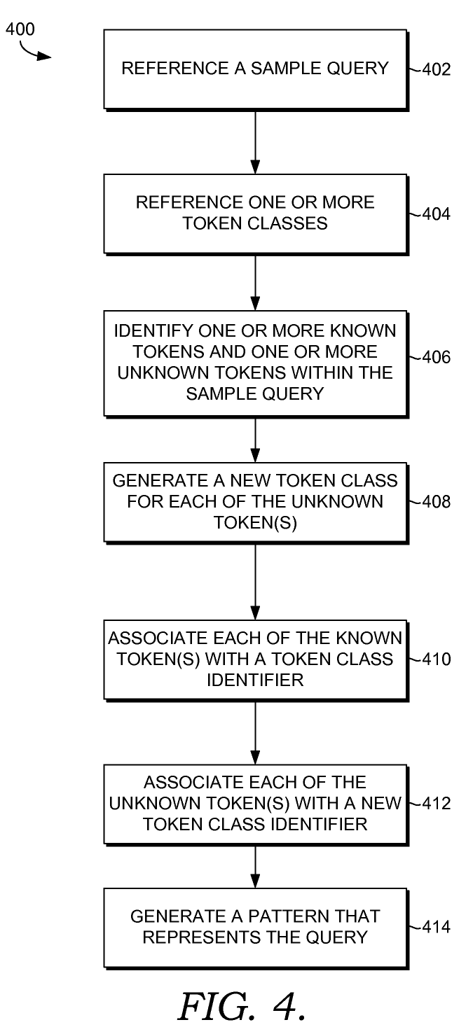

Referring now to FIG. 4, a flow diagram is provided that illustrates an overall method 400 for automatically generating patterns in accordance with an embodiment of the present invention. Initially, as shown at block 402, a sample query is referenced. At block 404, one or more token classes are referenced. Each of the token classes includes a set of related tokens. Subsequently, at block 406, one or more known tokens within the sample query and one or more unknown tokens within the sample query are identified. In one embodiment, the known tokens correspond with the one or more referenced token classes having the set or related tokens. A new token class is generated for each of the one or more unknown tokens. This is indicated at block 408. As indicated at block 410, a token class identifier is associated with each of the one or more known tokens and, at block 412, a new token class identifier is associated with each of the one or more unknown tokens. A pattern is generated at block 414. In one embodiment, a pattern is generated by substituting each of the known tokens with the associated token class identifier and each of the one or more unknown tokens with the associated new token class identifier.

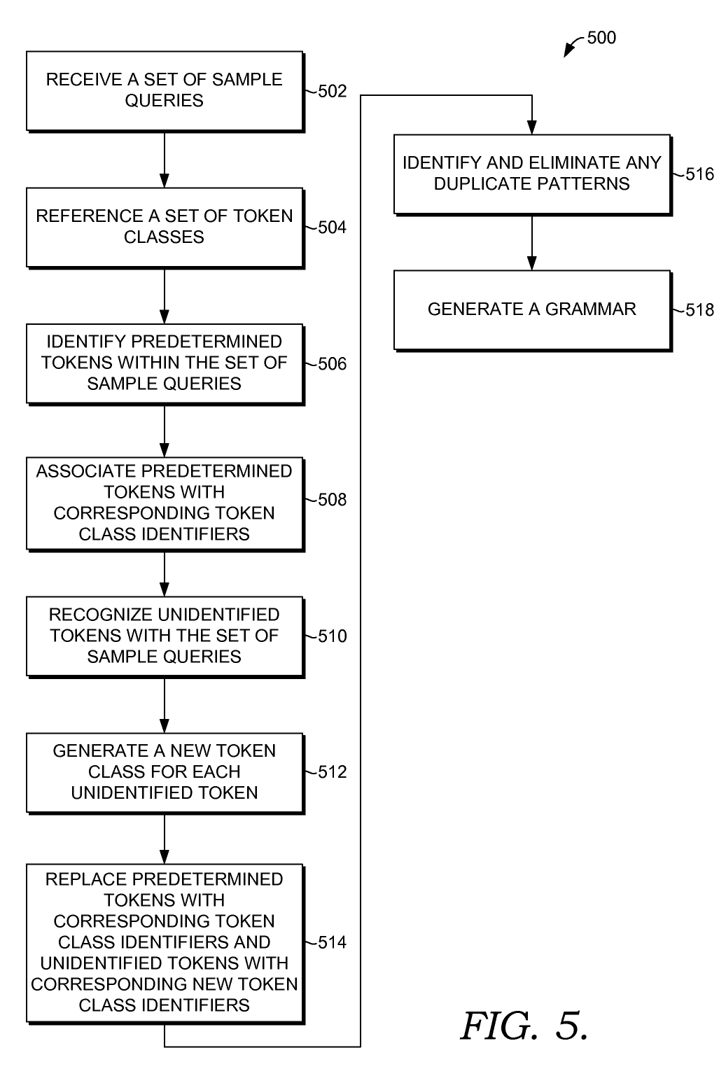

Turning now to FIG. 5, a flow diagram is provided that illustrates a more specific method 500 for generating patterns in accordance with an embodiment of the present invention. Initially, at block 502, a set of sample queries is received. In embodiments, the set of sample queries is input by one or more pattern generation users. At block 504, a set of token classes is referenced. Each of the token classes can be represented by a token class identifier and includes a group of related tokens. Thereafter, at block 506, the set of token classes is utilized to identify predetermined tokens within the set of sample queries. In embodiments, a predetermined token matches a token within the referenced set of token classes. Any predetermined tokens are associated with a corresponding token class identifier. This is indicated at block 508. As indicated at block 510, unidentified tokens within the sample queries are recognized. A new token class having a new token class identifier is generated for each of the unidentified tokens at block 512. At block 514, predetermined tokens within the sample queries are replaced with the corresponding token class identifier and unidentified tokens within the sample queries are replaced with the corresponding new token class identifier to generate patterns. Any duplicate patterns are identified and eliminated at block 516. A grammar is generated at block 518. Such a grammar is usable by a search engine to route search queries to corresponding domains of information to find and return information for the search queries.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combination are of utility and may be employed without reference to other features and sub-combinations. This is contemplated by and is within the scope of the claims.

The invention claimed is:

1. A method for generating patterns, the method comprising:
referencing a sample query, the sample query comprising a string of characters;
referencing a plurality of token classes, wherein each of the token classes within the plurality of token classes is associated with a token class identifier and comprises a logical grouping of tokens;
parsing the sample query to identify one or more predetermined tokens within the sample query that match at least one of the tokens corresponding with the plurality of referenced token classes; and
replacing each of the one or more predetermined tokens with the corresponding token class identifier to generate a pattern representing the sample query.

2. The method of claim 1 further comprising:
recognizing one or more unidentified tokens within the sample query;
generating a new token class for each of the one or more unidentified tokens; and
replacing each of the one or more unidentified tokens with the corresponding new token class.

3. The method of claim 2, wherein the one or more unidentified tokens refers to a single token comprising the string of characters within the sample query not identified as the one or more predetermined tokens.

4. The method of claim 2, wherein each of the one or more unidentified tokens comprises a word within the sample query not identified as the one or more predetermined tokens.

5. The method of claim 2, wherein at least one of the one or more unidentified tokens comprises a phrase not identified as the one or more predetermined tokens, wherein the phrase includes two or more words that appear adjacent to one another to a particular extent in other sample queries.

6. The method of claim 1, wherein the plurality of token classes correspond with one or more data sources.

7. The method of claim 1, wherein the token class identifier identifies the token class using a string of characters that comprise a word, a phrase, a regular expression, or a deterministic function.

8. The method of claim 1, wherein the pattern is included within a grammar usable by a search engine to route search queries to corresponding domains of information to find and return information for the search queries,

9. One or more computer-storage media embodying computer-useable instructions that, when employed by a computing device, cause the computing device to perform a method for generating patterns, the method comprising:
referencing a sample query;
referencing one or more token classes, each of the one or more token classes including a set of related tokens;
identifying one or more known tokens within the sample query and one or more unknown tokens within the sample query, wherein the one or more known tokens correspond with the one or more referenced token classes having the set of related tokens;
generating a new token class for each of the one or more unknown tokens;
associating a token class identifier with each of the one or more known tokens and a new token class identifier with each of the one or more unknown tokens; and
substituting each of the one or more known tokens with the associated token class identifier and each of the one or more unknown tokens with the associated new token class identifier to generate a pattern.

10. The one or more computer-storage media of claim 9, wherein the one or more unknown tokens comprises a token including the string of characters within the sample query not identified as the one or more predetermined tokens.

11. The one or more computer-storage media of claim 9, wherein each of the one or more unidentified tokens comprises a word within the sample query not identified as the one or more predetermined tokens.

12. The one or more computer-storage media of claim 9, wherein at least one of the one or more unidentified tokens comprises a phrase not identified as the one or more predetermined tokens, wherein the phrase includes two or more words that appear adjacent to one another to a particular extent in other sample queries.

13. The one or more computer-storage media of claim 9 further comprising providing annotations associated with the one or more known tokens, the one or more unknown tokens, the pattern, or a combination thereof.

14. The one or more computer-storage media of claim 9, wherein a token preference is utilized to identify one or more known tokens within the sample query, the token preference comprises a preference for the longest known token.

15. The one or more computer-storage media of claim 9, wherein the token class identifier and the new token class identifier represent the token class and new token class using a string of characters that comprise a word, a phrase, a regular expression, or a deterministic function.

16. The one or more computer-storage media of claim 9, wherein the one or more token classes correspond to a particular data source that contains related information.

17. The one or more computer-storage media of claim 9, wherein the pattern comprises a sequence of the token class identifiers and the new token class identifiers.

18. The one or more computer-storage media of claim 9 further comprising aggregating the pattern with the corresponding token classes and new token classes to generate a grammar.

19. The one or more computer-storage media of claim 18 further comprising aggregating the pattern with one or more other patterns to generate a grammar.

20. One or more computer-storage media embodying computer-useable instructions that, when employed by a computing device, cause the computing device to perform a method for automatically generating patterns, the method comprising:
receiving a set of sample queries, the set of sample queries input by one or more pattern generation users, wherein each of the sample queries comprises one or more characters;
referencing a set of token classes, each of the token classes represented by a token class identifier and comprising a group of related tokens;
utilizing the set of token classes to identify predetermined tokens within the set of sample queries, wherein a predetermined token is identified as such if it matches a token within the referenced set of token classes;
associating any predetermined tokens with the corresponding token class identifier;
recognizing unidentified tokens within the sample queries;
generating a new token class having a new token class identifier for each of the unidentified tokens;
generating a pattern for each of the sample queries, wherein patterns are generated by replacing any predetermined tokens within the sample queries with the corresponding token class identifier and replacing any unidentified tokens within the sample queries with the corresponding new token class identifier;
eliminating any duplicate patterns; and
generating a grammar usable by a search engine to route search queries to corresponding domains of information to find and return information for the search queries, the grammar comprising a version of each generated pattern, each pattern comprising a sequence of token class identifiers and new token class identifiers.
